(19) United States
(12) Patent Application Publication
(10) Pub. No.: US 2026/0050470 A1
(43) Pub. Date: Feb. 19, 2026

(54) METHOD AND APPARATUS FOR GENERATING INFORMATION, DEVICE AND STORAGE MEDIUM

(71) Applicant: Beijing Baidu Netcom Science Technology Co., Ltd., Beijing (CN)

(72) Inventors: Zhen ZHANG, Beijing (CN); Jinliang LU, Beijing (CN); Dai DAI, Beijing (CN); Zhi WU, Beijing (CN)

(21) Appl. No.: 19/368,700

(22) Filed: Oct. 24, 2025

(30) Foreign Application Priority Data
Jun. 17, 2025 (CN) 202510812187.3

(51) Int. Cl. G06F 9/48; G06F 40/40

(52) U.S. Cl. CPC G06F 9/4881; G06F 40/40

(57) ABSTRACT

A method for generating information is provided. The method includes determining a task type of a target task; determining a task evaluation dimension corresponding to the target task according to the task prompt word and the task type of the target task; generating an evaluation result corresponding to the task evaluation dimension according to the task evaluation dimension and the task result, where the task result is generated by a large language model according to a target task and a task prompt word; and determining target information of the target task according to the task evaluation dimension and the evaluation result.

### CROSS-REFERENCE TO RELATED APPLICATIONS

This application claims the priority from Chinese Patent Application No. 202510812187.3, filed on Jun. 17, 2025, the entire disclosure of which is hereby incorporated by reference.

### TECHNICAL FIELD

The present disclosure relates to the technical field of artificial intelligence, and more particularly, to the technical field of natural language processing, deep learning, large language models, and the like, and more particularly, to a method for generating information, a device, and a storage medium.

### BACKGROUND

In recent years, large-scale reinforcement learning (RL) has demonstrated breakthrough potential in natural-language processing and related fields. By imparting accurate information (e.g., reward signals) to the model, the reinforcement learning can effectively guide the model to generate responses that meet human preferences, and significantly improve the effect of the model on various tasks. The accuracy, stability and real-time availability of the reward signals are critical to the training effect, that is, only when stable, correct, and reasonable rewards are provided can the model be optimized in the desired direction.

### SUMMARY

The present disclosure provides a method for generating information, a device, and a storage medium.

According to a first aspect of the present disclosure, there is provided a method for generating information including: determining a task type of a target task; determining a task evaluation dimension corresponding to the target task according to the task prompt word and the task type of the target task; generating an evaluation result corresponding to the task evaluation dimension according to the task evaluation dimension and the task result, where the task result is generated by a large language model according to a target task and a task prompt word; and determining target information of the target task according to the task evaluation dimension and the evaluation result.

According to a second aspect of the present disclosure, there is provided an electronic device including at least one processor; and a memory in communication with the at least one processor; where the memory stores instructions executable by the at least one processor, the instructions being executed by the at least one processor to enable the at least one processor to perform the method as described in any of embodiments of the first aspect.

According to a third aspect of the present disclosure, there is provided a non-transitory computer readable storage medium storing computer instructions for causing a computer to perform a method as described in any of embodiments of the first aspect.

It should be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF THE DRAWINGS

The drawings are for a better understanding of the present disclosure and do not constitute a limitation of the present disclosure. Here:

FIG. 1 is an example system architecture diagram in which the present disclosure may be applied;

FIG. 2 is a flowchart of a method for generating information according to a first embodiment of the present disclosure;

FIG. 3 is a flowchart of a method for generating information according to a second embodiment of the present disclosure;

FIG. 4 is a flowchart of a method for generating information according to a third embodiment of the present disclosure;

FIG. 5 is a flowchart of a method for generating information according to a fourth embodiment of the present disclosure;

FIG. 6 is a flowchart of a method for generating information according to a fifth embodiment of the present disclosure;

FIG. 7 is a schematic structural diagram of an apparatus for generating information according to an embodiment of the present disclosure;

FIG. 8 is a block diagram of an electronic device for implementing a method for generating information according to an embodiment of the present disclosure.

### DETAILED DESCRIPTION OF EMBODIMENTS

The following description of exemplary embodiments of the present disclosure, taken in conjunction with the accompanying drawings, includes various details of embodiments of the present disclosure to facilitate understanding, and is to be considered as exemplary only. Accordingly, one of ordinary skill in the art will recognize that various changes and modifications may be made to the embodiments described herein without departing from the scope and spirit of the disclosure. Also, for clarity and conciseness, descriptions of well-known functions and structures are omitted from the following description.

It should be noted that the embodiments in the present disclosure and the features in the embodiments may be combined with each other without conflict. The present disclosure will now be described in detail with reference to the accompanying drawings and examples.

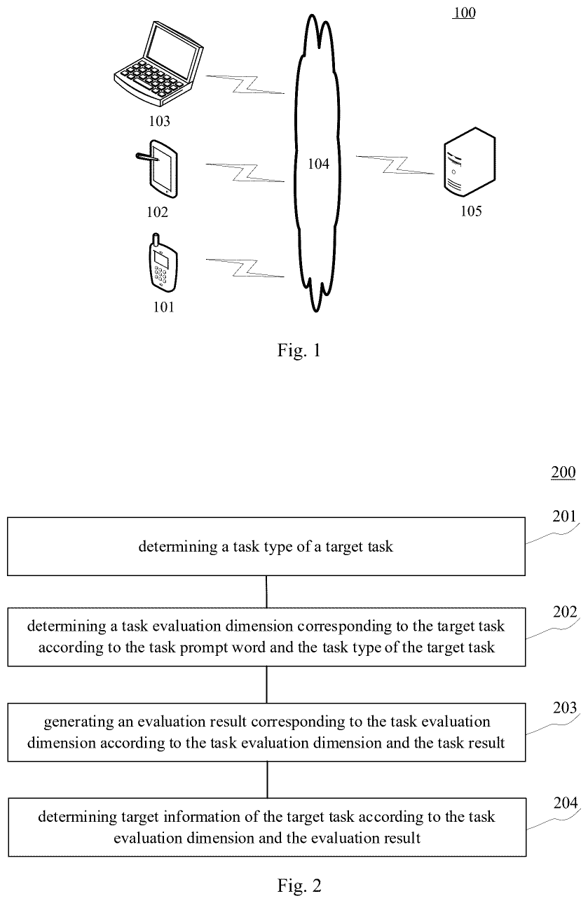

FIG. 1 illustrates an example system architecture 100 to which an embodiment of a method for generating information or an apparatus for generating information of the present disclosure may be applied.

As shown in FIG. 1, the system architecture 100 may include terminal devices 101, 102, 103, a network 104, and a server 105. The network 104 serves as a medium for providing a communication link between the terminal devices 101, 102, 103 and the server 105. Network 104 may include various types of connections, such as wired, wireless communication links, or fiber optic cables, among others.

The user may interact with the server 105 through the network 104 using the terminal devices 101, 102, 103 to receive or transmit information or the like. Various client applications may be installed on the terminal devices 101, 102, 103.

The terminal devices 101, 102, 103 may be hardware or software. When the terminal devices 101, 102, 103 are hardware, various electronic devices may be used, including but not limited to a smartphone, a tablet computer, a laptop computer, a desktop computer, and the like. When the terminal devices 101, 102, and 103 are software, they may be installed in the electronic device, which may be implemented as a plurality of software pieces or software modules, or as a single software piece or software module, which is not specifically limited herein.

The server 105 may provide various services. For example, the server 105 may analyze and process the target tasks and task prompts acquired from the terminal devices 101, 102, 103, and generate processing results (e.g., target information).

It should be noted that the server 105 may be hardware or software. When the server 105 is hardware, it may be implemented as a cluster of multiple servers or as a single server. When the server 105 is software, it may be implemented as a plurality of software pieces or software modules (e.g., for providing distributed services) or as a single software piece or software module, which is not specifically limited herein.

It should be noted that the method for generating information provided in the embodiments of the present disclosure is generally executed by the server 105, and accordingly, the apparatus for generating information is generally provided in the server 105.

It should be understood that the number of terminal devices, networks and servers in FIG. 1 is merely illustrative. There may be any number of terminal devices, networks, and servers as desired for implementation.

With continuing reference to FIG. 2, there is shown a flow 200 of a method for generating information according to a first embodiment of the present disclosure. The method for generating information includes the following steps.

Step 201 includes determining a task type of a target task.

In the present embodiment, the execution body of the method for generating information (for example, the server 105 shown in FIG. 1) first determines the task type of the target task. Specifically, the execution body first acquires the target task and the related information of the target task, such as the task content and the task prompt word. After acquiring the related information of the target task, the execution body parses the related information of the target task, such as the task prompt word corresponding to the target task, so as to determine the task type of the target task according to the parsing result, where the task type may be a translation task, a creative task, or the like. Specifically, the translation task refers to a task of translating content from one language to another, and a creative task generally refers to a literary creation task, that is, a process of creating a literary work through artistic processing for readers to appreciate.

Step 202 includes: determining a task evaluation dimension corresponding to the target task according to the task prompt word and the task type of the target task.

In this embodiment, the execution body determines a task evaluation dimension corresponding to a target task according to a task prompt word and a task type of the target task, where the task prompt word is a prompt word corresponding to the target task, and the prompt word refers to a key instruction in an input sample during fine tuning of a large model and task processing. For example, when the task type of the target task is the creative task, the task prompt word of the target task may be “Please create a lyrical text according to the following content”;

In addition, after determining the task type of the target task, the execution body further determines the target policy corresponding to the task type from the pre-constructed task policy library, that is, the task policy library in this embodiment includes task policies corresponding to multiple tasks, and different tasks correspond to different task policies. Therefore, after determining the task type of the target task, the execution body may determine the target policy corresponding to the task type of the target task from the task policy library according to the corresponding relationship between the task type and the task policy.

Then, a task evaluation dimension corresponding to the target task is obtained by performing dimension evaluation on the task prompt word according to the target policy, where the task evaluation dimension may be at least one. If the task evaluation dimension is represented by d, the task evaluation dimension corresponding to the target task may be expressed as d₁ [symbol] d₂ . . . dₙ, where n≥1.

As an example, when the task type of the target task is a creative task, the determined task evaluation dimensions for the target task may include: high texture, word count adherence, and instruction compliance.

Step 203 includes: generating an evaluation result corresponding to the task evaluation dimension according to the task evaluation dimension and the task result.

In this embodiment, the execution body generates the evaluation result corresponding to the task evaluation dimension according to the task evaluation dimension and the task result, where the task result is generated by the large language model according to the target task and the task prompt word.

It should be noted that in the field of artificial intelligence, a large language model (which may be simply referred to as a large model) refers to a deep neural network having more than 1 billion parameters capable of processing massive data, performing various complex tasks, such as natural language processing, computer vision, speech recognition, and the like. A generative large model refer to a large-scale corpus-based generative model, which refer to a large-scale neural network modes capable of generating, understanding and inferring natural languages in an end-to-end manner. By training over a large amount of text data, a wide range of tasks may be performed, including text summarization, translation, emotional analysis, and the like. A large model refers to a deep neural network with more than 1 billion parameters, capable of processing massive data and accomplishing various complex tasks. With the continuous improvement of computer hardware performance and the continuous optimization of deep learning algorithms, the development of large models is becoming more and more rapid. The parameters of the large model are continuously expanded, and the training time is longer and longer, but the performance is improved accordingly. Large models are typically based on deep learning architectures, such as Transformer, so that they exhibit impressive capabilities over a variety of natural language processing tasks. Common large models may include, but are not limited to, ChatGPT, GPT-4, ERNIE, and the like.

Specifically, the execution body first inputs the target task and the task prompt word into the large model, thereby outputting a task result corresponding to the target task. For example, when the target task is a creative task and the task prompt word is “Please create a piece of lyric text according to the following content”, the target task and the task prompt word are input into the large model, and the generated lyric text is output.

Then, the execution body generates an evaluation result corresponding to the task evaluation dimension according to the task evaluation dimension and the task result, and the evaluation result is used to evaluate whether the task result meets a requirement. For example, when the task type is a translation task, the task result is a translation result, and the evaluation result is used to evaluate whether all words in the task result are accurately translated.

Step 204 includes determining target information of the target task according to the task evaluation dimension and the evaluation result.

In the present embodiment, the execution body determines target information of the target task by evaluating the task evaluation dimension and the evaluation result, where the target information may refer to reward information of the target task. In reinforcement learning, a reward is a core signal guiding an action of an agent within an environment. The reward delivers immediate feedback on the agent behavior, evaluates how good or bad an action is in a given state, and thereby influences future decisions of the agent.

Specifically, for an evaluation result of a task evaluation dimension, the execution body determines whether or not the evaluation of the current dimension is satisfied according to the evaluation result, thereby determining target information according to the determination result. For example, the evaluation result is compared with a preset threshold (e.g., 0) to determine whether the evaluation of the current dimension is satisfied or not according to the comparison result.

As an example, for the task evaluation dimension 2, when the evaluation result of the dimension is equal to 0, it indicates that the evaluation of the current dimension is not satisfied. In this case, the information of the last preceding task evaluation dimension of the current task evaluation dimension is returned as the target information. When the evaluation result of the dimension is greater than 0, it indicates that the evaluation result of the current dimension is fully satisfied or partially satisfied. In this case, the information of the current dimension is calculated. The result evaluation process of the next task evaluation dimension is then performed until final information, i.e., the target information, such as reward information, is obtained.

Currently, the reward signal for large model reinforcement learning is generally given by the reward model, which provides an overall, uniform score as feedback to the large model response by remembering the preference information labeled by the human. The current mainstream reward calculation method assigns a scalar reward information to the text through a unified reward model as a basis for further optimization of the model. However, reward models have the following drawbacks: they are limited by the distribution of training data and subjective biases, making it difficult to guarantee their generalization ability; furthermore, they tend to cause the problem of excessive reward optimization in the model during iterations, resulting in mediocre robustness. Additionally, the rewards provided by reward models have poor interpretability, and the correlation between the level of scores and the quality of responses is not fully consistent.

According to the method for generating information provided in the embodiment of the present disclosure, a task type of a target task is first determined, then a task evaluation dimension corresponding to the target task is determined according to the task prompt word and the task type of the target task, then an evaluation result corresponding to the task evaluation dimension is generated according to the task evaluation dimension and the task result, and finally target information of the target task is determined according to the task evaluation dimension and the evaluation result. According to the method for generating information of the present embodiment, an evaluation dimension corresponding to a task prompt word of a target task is first determined, and target information (such as reward information) corresponding to the target task is generated by combining multiple evaluation dimensions and an evaluation result corresponding to each evaluation dimension, thereby alleviating a transition optimization problem caused by fixed evaluation dimensions, and improving accuracy of the determined target information. In addition, the method for generating information in the present embodiment improves information generation efficiency and calculation efficiency by adopting an asynchronous mechanism, and the method can maximize resource utilization of a GPU (Graphics Processing Unit) and avoid waiting on the training end.

In addition, in the technical solution related to the present disclosure, the acquisition, storage, use, processing, transportation, provision, and disclosure of the related user personal information (such as the target task and the task prompt word related to the present disclosure) all comply with the provisions of the related laws and regulations, and do not violate the common order and good customs.

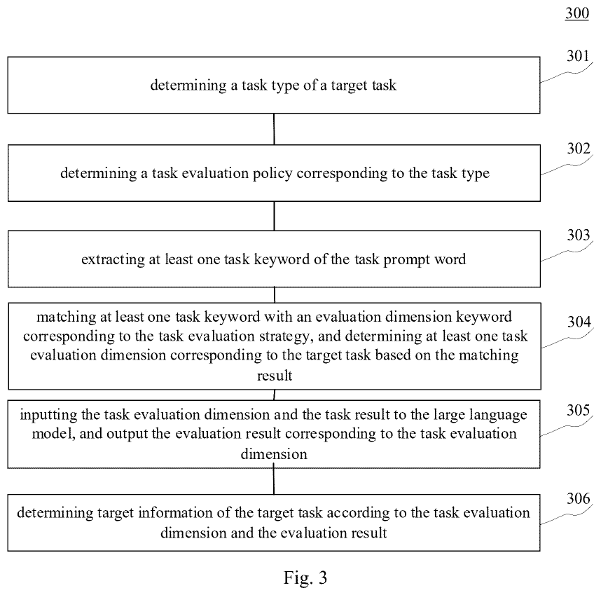

With continuing reference to FIG. 3, FIG. 3 illustrates a flow 300 of a method for generating information according to a second embodiment of the present disclosure. The method for generating information includes the following steps.

Step 301 includes determining a task type of a target task.

In the present embodiment, the execution body of the method for generating information (for example, the server 105 shown in FIG. 1) first determines the task type of the target task. Specifically, the execution body first acquires the target task, and related information of the target task, such as task contents and task prompts. After acquiring the related information of the target task, the execution body parses the related information of the target task, such as the task prompts corresponding to the target task, so as to determine a task type of the target task according to the parsing result, where the task type may be a translation task, a creative task, or the like. Specifically, the translation task refers to a task in which the content is translated from one language to another language, and the creative task generally refers to a literary creation task, that is, a process of creating a literary work through artistic processing for readers to appreciate.

Step 302 includes: determining a task evaluation policy corresponding to the task type.

In this embodiment, after determining the task type of the target task, the execution body further determines the target policy corresponding to the task type from the pre-constructed task policy library, that is, the task policy library in this embodiment includes task policies corresponding to multiple tasks, and different tasks correspond to different task policies. Therefore, after determining the task type of the target task, the execution body may determine the target policy corresponding to the task type of the target task from the task policy library according to the corresponding relationship between the task type and the task policy, that is, the task evaluation policy.

Step 303 includes extracting at least one task keyword of the task prompt word.

In the present embodiment, the execution body analyzes the task prompt word to determine at least one keyword corresponding to the task prompt word, that is, the task keyword.

Step 304 includes: matching at least one task keyword with an evaluation dimension keyword corresponding to the task evaluation strategy, and determining at least one task evaluation dimension corresponding to the target task based on the matching result.

In the present embodiment, because evaluation dimensions corresponding to different task evaluation strategies are different, the execution body first determines the evaluation dimension keywords corresponding to the task evaluation strategies, and then matches at least one task keyword with the evaluation dimension keywords respectively, so as to determine the task evaluation dimensions corresponding to the target task based on the matching result, where there are generally multiple task evaluation dimensions. If the task evaluation dimension is represented by d, then the task evaluation dimension corresponding to the target task can be represented as d₁ [symbol] d₂ . . . dₙ, where n≥1.

As an example, when the task type of the target task is an creative task, the determined task evaluation dimensions of the target task may include: high texture, word count adherence, and instruction compliance.

Therefore, the task evaluation strategy corresponding to the task type is first determined, and then the task evaluation dimension of the target task is determined according to the task evaluation strategy, so that the corresponding task evaluation dimensions are determined according to different task types, thereby improving the accuracy of the task evaluation dimension.

Step 305 includes: inputting the task evaluation dimension and the task result to the large language model, and output the evaluation result corresponding to the task evaluation dimension.

In the present embodiment, the execution body first inputs the target task and the task prompt word into the large model, thereby outputting a task result corresponding to the target task. For example, when the target task is a creative task and the task prompt word is “Please create a piece of lyric text according to the following contents the target task” the task prompt word and the target task are input into the large model, and the generated lyric text is output.

Then, the execution body inputs the task evaluation dimension and the task result into the large model, thereby outputting an evaluation result corresponding to the task evaluation dimension, and the evaluation result is used to evaluate whether the task result meets a requirement. For example, when the task type is a translation task, the task result is a translation result, and the evaluation result is used to evaluate whether all words in the task result are accurately translated.

Therefore, the evaluation result corresponding to the task evaluation dimension is accurately determined by the large model, and the target reward may be calculated according to the evaluation result, thereby improving the accuracy of the information result.

Step 306 includes: determining target information of the target task according to the task evaluation dimension and the evaluation result.

Step 306 is substantially consistent with step 204 of the foregoing embodiment. For a specific implementation, reference may be made to the foregoing description of step 204, and details are not described herein.

As can be seen from FIG. 3, compared with the embodiment corresponding to FIG. 2, the method for generating information in this embodiment highlights the steps of determining the task evaluation dimension corresponding to the target task and the evaluation result corresponding to the task evaluation dimension. Specifically, the method first determines the task evaluation strategy corresponding to the task type, then determines the task evaluation dimension of the target task based on this task evaluation strategy, and thus determines the corresponding task evaluation dimension according to different task types—this process improves the accuracy of the task evaluation dimension. In addition, the method also uses a large model to accurately determine the evaluation result corresponding to the task evaluation dimension; on this basis, the target information can be calculated according to these evaluation results, which further enhances the accuracy of the determined information.

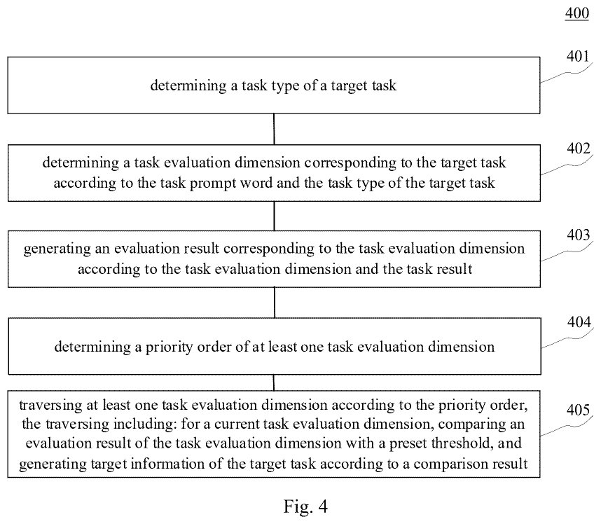

With continuing reference to FIG. 4, FIG. 4 illustrates a flow 400 of a method for generating information according to a third embodiment of the present disclosure. The method for generating information includes the following steps.

Step 401 includes: determining a task type of a target task.

Step 402 includes: determining a task evaluation dimension corresponding to the target task according to the task prompt word and the task type of the target task.

Step 403 includes: generating an evaluation result corresponding to the task evaluation dimension according to the task evaluation dimension and the task result.

Step 401-403 is substantially consistent with step 201-203 of the foregoing embodiment. For a specific implementation, reference may be made to the foregoing description of step 201-203, and details are not described herein.

Step 404 includes determining a priority order of at least one task evaluation dimension.

In the present embodiment, the execution body of the method for generating information (for example, the server 105 shown in FIG. 1) evaluates the priority of the multiple task evaluation dimensions using the large model, thereby generating the priority order of the multiple task evaluation dimensions. When evaluating model output results, the priorities evaluated for different dimensions are often different.

For example, when evaluating a translation task, if some words are not translated, the score for the current translation is very low; however, if all words are translated but some are not translated accurately, the score is slightly higher than in the former case. That is to say, in translation tasks, the priority of the evaluation dimension “whether all words are translated” is higher than that of the evaluation dimension “whether words are translated accurately”.

For example, the task evaluation dimension corresponding to the target task may be expressed as d₁ [symbol] d₂ . . . dₙ, and the priority order corresponding to the multiple task evaluation dimensions is d₁>d₂ . . . >dₙ.

Step 405 includes: traversing at least one task evaluation dimension according to the priority order, the traversing including: for a current task evaluation dimension, comparing an evaluation result of the task evaluation dimension with a preset threshold, and generating target information of the target task according to a comparison result.

In this embodiment, after determining the priority order, the execution body traverses from high priority to low priority in accordance with the priority order, that is, the execution body traverses the multiple task evaluation dimensions in descending order of priority. For the currently traversed task evaluation dimension dᵢ, the execution body obtains the evaluation result corresponding to the current task evaluation dimension and compares the evaluation with a preset threshold. On this basis, the target information is determined according to the comparison result, where the target information includes reward information.

Since the evaluation result is used to indicate whether the evaluation of the current dimension is satisfied, the preset threshold is generally set to 0, that is, if the evaluation result is greater than 0, it indicates that the evaluation of the current dimension is fully satisfied or partially satisfied; and if the evaluation result is equal to 0, it indicates that the evaluation of the current dimension is not satisfied.

Further, if the evaluation of the current dimension is not satisfied, the information of the last preceding task evaluation dimension of the current task evaluation dimension is directly used as final information, that is, target information. If the evaluation of the current dimension is fully satisfied or partially satisfied, the current information of the current task evaluation dimension is calculated according to the information of the last preceding task evaluation dimension and the evaluation score corresponding to the current task evaluation dimension. Then, the traversal continues until all task evaluation dimensions have been traversed, or until the target information is generated and is output.

In this way, by determining the priority order of the evaluation dimensions and calculating the target information in accordance with this priority order, achieving satisfaction level by level from high priority to low priority, the comprehensiveness and accuracy of the information result are improved, which in turn enhances the user experience.

In some alternative implementations of the present embodiment, step 405 includes determining that the target information is information of a last preceding task evaluation dimension, in response to determining that the evaluation result of the task evaluation dimension is equal to a preset threshold, where the last preceding task evaluation dimension is a last preceding task evaluation dimension of the current task evaluation dimension.

In this implementation, since the execution body traverses all task evaluation dimensions in descending order of priority, if the executing entity determines that the evaluation result [symbol] of the current task evaluation dimension dᵢ is equal to the preset threshold (e.g., equal to 0), it indicates that the evaluation of the current dimension is not satisfied. In this case, the reward information rᵢ₋₁ of the task evaluation dimension preceding the current task evaluation dimension is directly output as the target information (target reward), i.e., the target reward information r=rᵢ₋₁.

By adopting a hierarchical reward fusion calculation strategy based on the priority of evaluation dimensions and determining the evaluation results of evaluation dimensions respectively, the finally generated target reward information is more accurate and targeted.

As can be seen from FIG. 4, compared with the embodiment corresponding to FIG. 3, the method for generating information in this embodiment highlights the step of calculating the target information based on the task evaluation dimension and evaluation result. Thus, through the hierarchical reward fusion calculation strategy based on the priority of evaluation dimensions, the evaluation results of evaluation dimensions are determined respectively, making the finally generated target information more accurate and targeted.

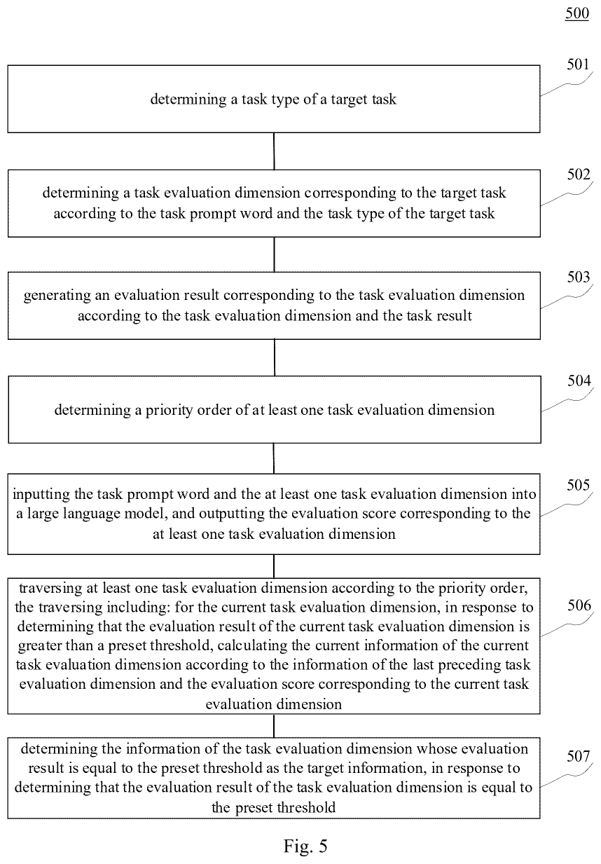

With continuing reference to FIG. 5, FIG. 5 illustrates a flow 500 of a method for generating information according to a fourth embodiment of the present disclosure. The method for generating information includes the steps of:

Step 501 includes: determining a task type of a target task.

Step 502 includes: determining a task evaluation dimension corresponding to the target task according to the task prompt word and the task type of the target task.

Step 503 includes: generating an evaluation result corresponding to the task evaluation dimension according to the task evaluation dimension and the task result.

Step 504 includes: determining a priority order of at least one task evaluation dimension.

Step 501-504 is substantially consistent with step 401-404 of the foregoing embodiment. For a specific implementation, reference may be made to the foregoing description of step 401-404, and details are not described herein.

Step 505 includes: inputting the task prompt word and the at least one task evaluation dimension into a large language model, and outputting the evaluation score corresponding to the at least one task evaluation dimension.

In the present embodiment, an execution body of the method for generating information (for example, the server 105 shown in FIG. 1) inputs a task prompt word and all task evaluation dimensions into the large model so that the large model scores the dimension importance of each task evaluation dimension, thereby outputting an evaluation score corresponding to each task evaluation dimension, that is, the evaluation score is used to represent the importance of the task evaluation dimension. The evaluation score for the task evaluation dimension dᵢ may be expressed as wᵢ.

Step 506 includes: traversing at least one task evaluation dimension according to the priority order, the traversing including: for the current task evaluation dimension, in response to determining that the evaluation result of the current task evaluation dimension is greater than a preset threshold, calculating the current information of the current task evaluation dimension according to the information of the last preceding task evaluation dimension and the evaluation score corresponding to the current task evaluation dimension.

In this embodiment, the execution body traverses all task evaluation dimensions according to the priority order of the task evaluation dimensions, for example, traverses the task evaluation dimensions in descending order of priority. If it is determined that the evaluation result [symbol] of the current task evaluation dimension dᵢ is greater than a preset threshold (for example [symbol] >0), it indicates that the evaluation of the current task evaluation dimension is fully satisfied or partially satisfied. In this case, the reward value (i.e., information rᵢ) of the current task evaluation dimension is calculated. Specifically rᵢ may be calculated according to the following formula:

$${r}_{i} = {r}_{i - 1} + {w}_{i} {\tilde{r}}_{ι} ;$$

where rᵢ₋₁ is the reward value of the last preceding task evaluation dimension and wᵢ is the evaluation score corresponding to the current evaluation task dimension.

Step 507 includes: determining the information of the task evaluation dimension whose evaluation result is equal to the preset threshold as the target information, in response to determining that the evaluation result of the task evaluation dimension is equal to the preset threshold.

In the present embodiment, the execution body continues the traversal, that is, traverses the next task evaluation dimension of the current task evaluation dimension in accordance with the priority order of the task evaluation dimensions, compares the reward value of the next task evaluation dimension with the preset threshold, generates the target reward value of the target task based on the comparison result, and outputs the finally generated target reward value.

Thus, when the evaluation result of the current task evaluation dimension is greater than the preset threshold, the current reward value of the current task evaluation dimension is calculated based on the reward value of the previous task evaluation dimension and the evaluation score corresponding to the current task evaluation dimension, and the traversal continues until the target reward value is obtained. By adopting a hierarchical reward fusion calculation strategy based on the priority of evaluation dimensions and determining the evaluation results of evaluation dimensions respectively, the finally generated target reward value is more accurate and targeted.

In some optional implementations of the present embodiment, the method further includes determining the information of the last traversed task evaluation dimension in the at least one task evaluation dimension as the target information in response to determining that all task evaluation dimensions have been traversed and that the evaluation result corresponding to each task evaluation dimension is not equal to a preset threshold.

In this implementation, if the traversal of all task evaluation dimensions has been completed, and the evaluation result of each task evaluation dimension is greater than a preset threshold (that is, the evaluation of all task evaluation dimensions is satisfied), the information (reward information) of the last traversed task evaluation dimension is output as target information (target reward). This ensures that the target reward value can be generated in such cases.

As can be seen from FIG. 5, compared with the embodiment corresponding to FIG. 4, the method for generating information in this embodiment highlights the step of calculating the target reward value according to the task evaluation dimension and the evaluation result, so that when the evaluation result of the current task evaluation dimension is greater than a preset threshold, the current reward value of the current task evaluation dimension is calculated according to the reward value of the last preceding task evaluation dimension and the evaluation score corresponding to the current task evaluation dimension, and the traversal is continued until the target reward value is obtained. By adopting a hierarchical reward fusion calculation strategy based on the priority of evaluation dimensions and determining the evaluation results of the evaluation dimensions respectively, the finally generated target reward value is more accurate and targeted.

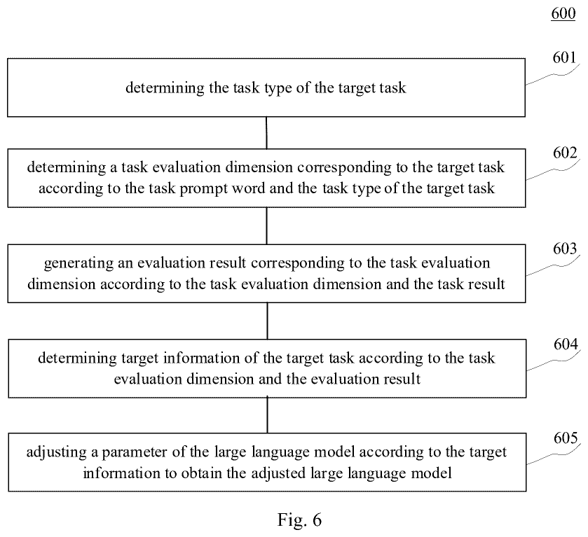

With continued reference to FIG. 6, a flow 600 of a method for generating information according to a fifth embodiment of the present disclosure is shown. The method for generating information includes the following steps.

Step 601 includes: determining the task type of the target task.

Step 602 includes: determining a task evaluation dimension corresponding to the target task according to the task prompt word and the task type of the target task.

Step 603 includes: generating an evaluation result corresponding to the task evaluation dimension according to the task evaluation dimension and the task result.

Step 604 includes: determining target information of the target task according to the task evaluation dimension and the evaluation result.

Steps 601-604 are substantially consistent with step 201-204 of the foregoing embodiment. For a specific implementation, reference may be made to the foregoing description of step 201-204, and details are not described herein.

Step 605 includes: adjusting a parameter of the large language model according to the target information to obtain the adjusted large language model.

In the present embodiment, the execution body of the method for generating information (for example, the server 105 shown in FIG. 1) adjusts the parameter of the large model according to the generated target information, that is, the large model may be optimized according to the target reward information. Here, the large model is regarded as an agent, and the reward information serves as environmental feedback; and the model is driven to iteratively update by using the reward information.

As can be seen from FIG. 6, compared with the embodiment corresponding to FIG. 2, the method for generating information in the present embodiment highlights the step of adjusting the large model parameter according to the target information (e.g., the target reward information). The present embodiment generates the target information by using the asynchronous mechanism, thereby improving the resource utilization rate of the GPU and avoiding the waiting on the training end. Moreover, by adjusting the parameter of the large model by using the target information to optimize the large model, the training efficiency of the model and the optimization efficiency of the model are improved, and the method supports large-scale training tasks.

Further, in some application scenarios, a reward system for mass learning is also provided. The award system adopts an asynchronous, batch-processing, highly scalable design that provides the following capabilities:
1) A pluggable Verifier (validator) design with a multi-Verifier combination mechanism, which replaces the traditional single reward model approach, adapts to different types of Reinforcement Learning (RL) tasks, and makes Reward calculation more accurate and interpretable. Here, each Verifier corresponds to one type of task.
2) An asynchronous Reward calculation mechanism, which maximizes GPU resource utilization and avoids waiting on the training end.
3) An independent Verifier evaluation system, which prevents the model from “learning” the Reward calculation logic through training strategies.
4) A high-concurrency architecture that supports large-scale training tasks, thereby ensuring that Reward calculation does not become a bottleneck in training.

As an integrated system, this reward system does not pursue a unified reward model; instead, it can assign a more targeted Verifier or Reward Model (uniformly normalized to the range of 0-1) to each query. This ensures that the rewards returned by the reward system are sufficiently accurate and effectively guide model optimization.

Based on this system, a method for calculating reward information for different tasks may be further provided. The generation method of this reward information is a sample-inspired multi-level reward fusion method, which combines multiple evaluation dimensions to calculate a more accurate and reasonable unified reward score for each query. This method involves sample-inspired multi-dimensional reward weight calculation and a hierarchical reward fusion strategy based on evaluation priority.

Specifically, the sample-inspired multi-dimensional reward weight calculation process is as follows:

For a given Prompt, the large model is first required to analyze the main evaluation dimensions d₁ [symbol] d₂ . . . dₙ covered by the user requirements behind the Prompt.

Subsequently, the Prompt and the extracted evaluation dimensions are fed into the large model again, and the model is required to score the importance of these evaluation dimensions, obtaining scores w₁, w₂ . . . wₙ. These scores are used as weights for subsequent multi-dimensional reward fusion.

The hierarchical reward fusion strategy based on evaluation priority includes the following.

When evaluating the output results of a model, the priorities of evaluations for different dimensions are often different. For example, when evaluating a translation task, if some words are not translated at all, the score of the current translation is very low; however, if all words are translated but some are not translated accurately, the score is higher than in the former case. That is, in translation tasks, the priority of “whether all words are translated” is higher than that of “whether the translation results are accurate”.

Therefore, a hierarchical reward fusion method based on evaluation priority is provided, specifically:
(1) For a given Prompt, the large model is used to evaluate the priority order of different dimensions d₁ [symbol] d₂ . . . dₙ of the current Prompt, assuming the priority order is: d₁>d₂ . . . >dₙ.
(2) According to the obtained order, traversing is performed from high priority to low priority step by step as follows.
A. For the i-th level dimension dᵢ, the evaluation result is [symbol] , and the dimension importance evaluation score is wᵢ;
1) If [symbol] =0, it indicates that the evaluation of the current dimension is not satisfied. In this case, the final reward is directly returned as r=rᵢ₋₁
2) If [symbol] >0, it indicates that the evaluation of the current dimension is fully or partially satisfied. In this case, the reward for the current level is calculated as rᵢ=rᵢ₋₁+w [symbol] .
B. The above process is repeated until the final reward r is obtained.

The sample-inspired evaluation strategy ensures that the evaluation is closely associated with the current user request, and the covered dimensions are more targeted, which can alleviate to a certain extent the problems of excessive optimization and reward hacking caused by fixed evaluation dimensions. In addition, the reward fusion method based on evaluation priority aligns with human preferences, can improve to a certain extent the “red line” issues that may occur in the model, and achieves satisfaction level by level from high priority to low priority, thereby enhancing the user experience.

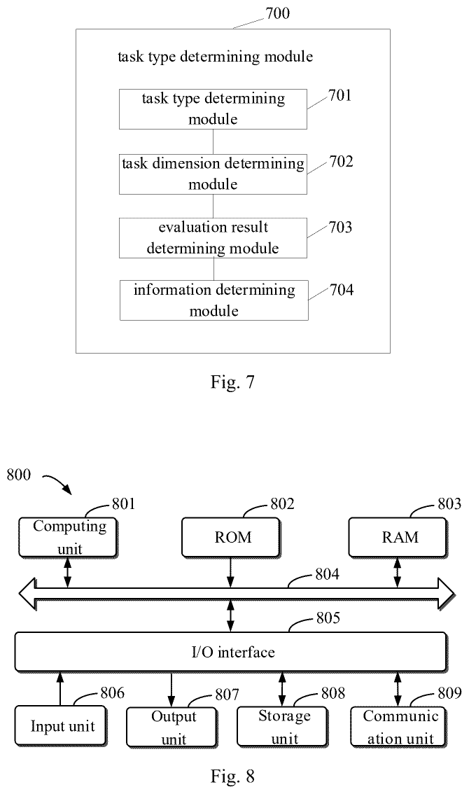

With further reference to FIG. 7, as an implementation of the method shown in each of the above figures, the present disclosure provides an embodiment of an apparatus for generating information which corresponds to the method embodiment shown in FIG. 2 and which is particularly applicable to various electronic devices.

As shown in FIG. 7, the apparatus for generating information 700 of the present embodiment includes a task type determining module 701, a task dimension determining module 702, an evaluation result determining module 703, and an information determining module 704. The task type determining module 701 is configured to determine a task type of a target task; the task dimension determining module 702 is configured to determine a task evaluation dimension corresponding to the target task according to a task prompt word and the task type of the target task; the evaluation result determining module 703 is configured to generate an evaluation result corresponding to the task evaluation dimension according to the task evaluation dimension and the task result, where the task result is generated by the large language model according to the target task and the task prompt word; and the information determination module 704 is configured to determine target information for a target task based on the task evaluation dimension and the evaluation result.

In the present embodiment, the specific processing of the task type determining module 701, the task dimension determining module 702, the evaluation result determining module 703, and the information determining module 704 and the technical effects thereof may be described with reference to the related description of step 201-204 in the corresponding embodiment in FIG. 2, and details are not described herein.

In some alternative implementations of the present embodiment, the task dimension determination module 702 is further configured to determine a task evaluation policy corresponding to the task type; extract at least one task keyword of the task prompt word; and match at least one task keyword with an evaluation dimension keyword corresponding to the task evaluation strategy, and determine at least one task evaluation dimension corresponding to the target task based on the matching result.

In some alternative implementations of the present embodiment, the evaluation result determining module 703 is further configured to input the task evaluation dimension and the task result to the large language model, and output the evaluation result corresponding to the task evaluation dimension.

In some alternative implementations of the present embodiment, the information determination module 704 includes a priority determination submodule configured to determine a priority order of at least one task evaluation dimension; an information calculation submodule configured to traverse at least one task evaluation dimension according to a priority order, the traversing includes: for a current task evaluation dimension, comparing an evaluation result of the task evaluation dimension with a preset threshold, and generating target information of a target task according to the comparison result, where the target information includes reward information.

In some alternative implementations of the present embodiment, the reward calculation sub-module includes a first reward calculation unit configured to determine target information being information of a last preceding task evaluation dimension in response to determining that an evaluation result of the task evaluation dimension is equal to a preset threshold, where the last preceding task evaluation dimension is a last preceding task evaluation dimension of the current task evaluation dimension.

In some alternative implementations of the present embodiment, the apparatus for generating information 700 further includes an evaluation score calculation module configured to input a task prompt word and at least one task evaluation dimension into a large language model and output an evaluation score corresponding to the at least one task evaluation dimension, where the evaluation score is used to represent the importance of the task evaluation dimension; and the information calculation submodule further includes a second reward calculation unit configured to calculate the current information of the current task evaluation dimension according to the information of the last preceding task evaluation dimension and the evaluation score corresponding to the current task evaluation dimension in response to determining that the evaluation result of the task evaluation dimension is greater than a preset threshold; and determine information of the task evaluation dimension whose evaluation result is equal to the preset threshold as target information, in response to determining that the evaluation result of the task evaluation dimension is equal to the preset threshold.

In some alternative implementations of the present embodiment, the apparatus for generating information 700 further includes a determining module configured to determine, in response to determining that all task evaluation dimensions have been traversed and that the evaluation result corresponding to each task evaluation dimension is not equal to a preset threshold, the information of the last traversed task evaluation dimension in the at least one task evaluation dimension as the target information.

In some alternative implementations of the present embodiment, the apparatus for generating information 700 further includes an updating module configured to adjust a parameter of the large language model according to the target information to obtain the adjusted large language model.

According to an embodiment of the present disclosure, the present disclosure also provides an electronic device, a readable storage medium, and a computer program product.

FIG. 8 illustrates a schematic block diagram of an example electronic device 800 that may be used to implement embodiments of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 8, the apparatus 800 includes a computing unit 801, which may perform various appropriate actions and processes according to a computer program stored in a read-only memory (ROM) 802 or a computer program loaded into a random access memory (RAM) 803 from a storage unit 808. In RAM 803, various programs and data required for operation of the device 800 may also be stored. The computing units 801, ROM 802 and RAM 803 are connected to each other via a bus 804. An input/output (I/O) interface 805 is also connected to bus 804.

A plurality of components in the device 800 are connected to the I/O interface 805, including an input unit 806, such as a keyboard, a mouse, and the like; an output unit 807, for example, various types of displays, speakers, and the like; a storage unit 808, such as a magnetic disk, an optical disk, or the like; and a communication unit 809, such as a network card, a modem, or a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Some examples of computing units 801 include, but are not limited to, central processing units (CPUs), graphics processing units (GPUs), various specialized artificial intelligence (AI) computing chips, various computing units that run machine learning model algorithms, digital signal processors (DSPs), and any suitable processors, controllers, microcontrollers, and the like. The computing unit 801 performs various methods and processes described above, such as a method for generating information. For example, in some embodiments, the method for generating information may be implemented as a computer software program tangibly embodied in a machine-readable medium, such as a storage unit 808. In some embodiments, some or all of the computer program may be loaded and/or installed on the device 800 via the ROM 802 and/or the communication unit 809. When the computer program is loaded to the RAM 803 and executed by the computing unit 801, one or more steps of the method for generating information described above may be performed. Alternatively, in other embodiments, the computing unit 801 may be configured to perform the method for generating information by any other suitable means (e.g., by means of firmware).

The various embodiments of the systems and techniques described above herein may be implemented in a digital electronic circuit system, an integrated circuit system, a field programmable gate array (FPGA), an application specific integrated circuit (ASIC), a special purpose standard product (ASSP), a system on a system on a chip (SOC), a load programmable logic device (CPLD), computer hardware, firmware, software, and/or combinations thereof. These various embodiments may include being implemented in one or more computer programs that may execute and/or interpret on a programmable system including at least one programmable processor, which may be a dedicated or general purpose programmable processor that may receive data and instructions from a memory system, at least one input device, and at least one output device, and transmit the data and instructions to the memory system, the at least one input device, and the at least one output device.

The program code for carrying out the methods of the present disclosure may be written in any combination of one or more programming languages. These program codes may be provided to a processor or controller of a general purpose computer, special purpose computer, or other programmable data processing apparatus such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more wire-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; and a keyboard and a pointing device (e.g., a mouse or a trackball) through which a user can provide input to a computer. Other types of devices may also be used to provide interaction with a user; for example, the feedback provided to the user may be any form of sensory feedback (e.g., visual feedback, auditory feedback, or tactile feedback); and input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other. The server may be a cloud server, a server of a distributed system, or a server incorporating a chain of blocks.

It should be understood that the steps of reordering, adding or deleting may be performed using the various forms shown above. For example, the steps described in the present disclosure may be performed in parallel or sequentially or in a different order, so long as the desired results of the technical solution disclosed in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A method for generating information, comprising:
determining a task type of a target task;
determining a task evaluation dimension corresponding to the target task according to a task prompt word of the target task and the task type;
generating an evaluation result corresponding to the task evaluation dimension according to the task evaluation dimension and a task result, wherein the task result is generated by a large language model according to the target task and the task prompt word; and
determining target information of the target task according to the task evaluation dimension and the evaluation result.

2. The method according to claim 1, wherein the determining the task evaluation dimension corresponding to the target task based on the task prompt word of the target task and the task type comprises:
determining a task evaluation strategy corresponding to the task type;
extracting at least one task keyword of the task prompt word; and
matching the at least one task keyword with an evaluation dimension keyword corresponding to the task evaluation strategy, and determining at least one task evaluation dimension corresponding to the target task based on a matching result.

3. The method according to claim 1, wherein the generating the evaluation result corresponding to the task evaluation dimension based on the task evaluation dimension and the task result comprises:
inputting the task evaluation dimension and the task result to the large language model, and outputting an evaluation result corresponding to the task evaluation dimension.

4. The method according to claim 2, wherein the determining target information of the target task based on the task evaluation dimension and the evaluation result comprises:
determining a priority order of the at least one task evaluation dimension; and
traversing the at least one task evaluation dimension according to the priority order, wherein the traversing comprises: for a current task evaluation dimension, comparing an evaluation result of the current task evaluation dimension with a preset threshold, and generating target information of the target task according to a comparison result, wherein the target information comprises reward information.

5. The method according to claim 4, wherein the generating target information of the target task according to the comparison result comprises:
in response to determining that the evaluation result of the task evaluation dimension is equal to the preset threshold, determining that the target information is information of a last preceding task evaluation dimension, wherein the last preceding task evaluation dimension is the last preceding task evaluation dimension of the current task evaluation dimension.

6. The method according to claim 5, further comprising:
inputting the task prompt word and the at least one task evaluation dimension into a large language model, and outputting an evaluation score corresponding to the at least one task evaluation dimension, wherein the evaluation score is used to represent importance of the task evaluation dimension; and
the generating the target information of the target task according to the comparison result further comprises:
calculating current information of the current task evaluation dimension according to the information of the last preceding task evaluation dimension and the evaluation score corresponding to the current task evaluation dimension, in response to determining that the evaluation result of the task evaluation dimension is greater than the preset threshold; and
determining information of a task evaluation dimension whose evaluation result is equal to the preset threshold as the target information, in response to determining that the evaluation result of the task evaluation dimension is equal to the preset threshold.

7. The method according to claim 6, further comprising:
in response to determining that all task evaluation dimensions have been traversed and that the evaluation result corresponding to each task evaluation dimension is not equal to the preset threshold, determining information of the last traversed task evaluation dimension in the at least one task evaluation dimension as the target information.

8. The method according to claim 1, further comprising:
adjusting a parameter of the large language model according to the target information to obtain an adjusted large language model.

9. An electronic device comprising:
at least one processor; and
a memory in communication with the at least one processor;
wherein the memory stores instructions executable by the at least one processor to enable the at least one processor to perform operations comprising:
determining a task type of a target task;
determining a task evaluation dimension corresponding to the target task according to a task prompt word of the target task and the task type;
generating an evaluation result corresponding to the task evaluation dimension according to the task evaluation dimension and a task result, wherein the task result is generated by a large language model according to the target task and the task prompt word; and
determining target information of the target task according to the task evaluation dimension and the evaluation result.

10. The electronic device according to claim 9, wherein the determining the task evaluation dimension corresponding to the target task based on the task prompt word of the target task and the task type comprises:
determining a task evaluation strategy corresponding to the task type;
extracting at least one task keyword of the task prompt word; and
matching the at least one task keyword with an evaluation dimension keyword corresponding to the task evaluation strategy, and determining at least one task evaluation dimension corresponding to the target task based on a matching result.

11. The electronic device according to claim 9, wherein the generating the evaluation result corresponding to the task evaluation dimension based on the task evaluation dimension and the task result comprises:
inputting the task evaluation dimension and the task result to the large language model, and outputting an evaluation result corresponding to the task evaluation dimension.

12. The electronic device according to claim 10, wherein the determining target information of the target task based on the task evaluation dimension and the evaluation result comprises:
determining a priority order of the at least one task evaluation dimension; and
traversing the at least one task evaluation dimension according to the priority order, wherein the traversing comprises: for a current task evaluation dimension, comparing an evaluation result of the current task evaluation dimension with a preset threshold, and generating target information of the target task according to a comparison result, wherein the target information comprises reward information.

13. The electronic device according to claim 12, wherein the generating target information of the target task according to the comparison result comprises:
in response to determining that the evaluation result of the task evaluation dimension is equal to the preset threshold, determining that the target information is information of a last preceding task evaluation dimension, wherein the last preceding task evaluation dimension is the last preceding task evaluation dimension of the current task evaluation dimension.

14. The electronic device according to claim 13, wherein the operations further comprise:
inputting the task prompt word and the at least one task evaluation dimension into a large language model, and outputting an evaluation score corresponding to the at least one task evaluation dimension, wherein the evaluation score is used to represent importance of the task evaluation dimension; and
the generating the target information of the target task according to the comparison result further comprises:
calculating current information of the current task evaluation dimension according to the information of the last preceding task evaluation dimension and the evaluation score corresponding to the current task evaluation dimension, in response to determining that the evaluation result of the task evaluation dimension is greater than the preset threshold; and
determining information of a task evaluation dimension whose evaluation result is equal to the preset threshold as the target information, in response to determining that the evaluation result of the task evaluation dimension is equal to the preset threshold.

15. The electronic device according to claim 14, wherein the operations further comprise:
in response to determining that all task evaluation dimensions have been traversed and that the evaluation result corresponding to each task evaluation dimension is not equal to the preset threshold, determining information of the last traversed task evaluation dimension in the at least one task evaluation dimension as the target information.

16. The electronic device according to claim 9, further comprising:
adjusting a parameter of the large language model according to the target information to obtain an adjusted large language model.

17. A non-transitory computer-readable storage medium storing computer instructions for causing the computer to perform operations comprising:
determining a task type of a target task;
determining a task evaluation dimension corresponding to the target task according to a task prompt word of the target task and the task type;
generating an evaluation result corresponding to the task evaluation dimension according to the task evaluation dimension and a task result, wherein the task result is generated by a large language model according to the target task and the task prompt word; and
determining target information of the target task according to the task evaluation dimension and the evaluation result.

18. The computer-readable storage medium according to claim 17, wherein the determining the task evaluation dimension corresponding to the target task based on the task prompt word of the target task and the task type comprises:
determining a task evaluation strategy corresponding to the task type;
extracting at least one task keyword of the task prompt word; and
matching the at least one task keyword with an evaluation dimension keyword corresponding to the task evaluation strategy, and determining at least one task evaluation dimension corresponding to the target task based on a matching result.

19. The computer-readable storage medium according to claim 17, wherein the generating the evaluation result corresponding to the task evaluation dimension based on the task evaluation dimension and the task result comprises:
inputting the task evaluation dimension and the task result to the large language model, and outputting an evaluation result corresponding to the task evaluation dimension.

20. The computer-readable storage medium according to claim 18, wherein the determining target information of the target task based on the task evaluation dimension and the evaluation result comprises:
determining a priority order of the at least one task evaluation dimension; and
traversing the at least one task evaluation dimension according to the priority order, wherein the traversing comprises: for a current task evaluation dimension, comparing an evaluation result of the current task evaluation dimension with a preset threshold, and generating target information of the target task according to a comparison result, wherein the target information comprises reward information.
